(19) United States
(12) Patent Application Publication
(10) Pub. No.: US 2002/0038802 A1
(43) Pub. Date: Apr. 4, 2002

(54) Aluminum foil crock pot inserts

(76) Inventor: Martha L. Von Tersch, Sherrard, IL (US)

Correspondence Address: HENDERSON & STURM LLP, 1213 MIDLAND BUILDING, 206 SIXTH AVENUE, DES MOINES, IA, 50309-4076, US

(21) Appl. No.: 09/966,471

(22) Filed: Sep. 28, 2001

Related U.S. Application Data
(60) Provisional application No. 60/237,321, filed on Oct. 2, 2000.

(51) Int. Cl. A47J 27/00; A47J 36/00

(52) U.S. Cl. 220/573.4

(57) ABSTRACT

This invention provides an aluminum foil insert that fits into a crock pot. The insert may include one or more divided compartments for separation of different foods to be heated. For example, a two-compartment insert could hold combinations such as ½ cheese dip and ½ bean dip; ½ meat balls and ½ cocktail wieners; or ½ chicken noodle soup and ½ chili. It is understood that the aluminum foil insert could be made in a variety of sizes and shapes, each of which would be matingly received in the interior of a crock pot of like size and shape.

### CROSS REFERENCE TO RELATED APPLICATIONS

This application contains disclosure from and claims the benefit under Title 35 United States Code § 119(e) of United States Provisional Application Serial No. 60/237,321, filed Oct. 2, 2000 and entitled “Aluminum Foil Crock Pot Insert”.

### STATEMENT REGARDING FEDERALLY SPONSORED RESEARCH OR DEVELOPMENT

Not applicable.

### REFERENCE TO MICROFICHE APPENDIX

Not applicable.

### BACKGROUND OF THE INVENTION

1. Field of the Invention

The present invention relates to the field of cookware, and more particularly to an aluminum foil crock pot insert.

2. Description of Related Art

The prior art discloses myriad and diverse crock pot accessories. While all of the aforementioned prior art constructions are more than adequate for the basic purpose and function for which they have been specifically designed, they are uniformly deficient with respect to their failure to provide a simple, efficient, and practical crock pot insert suitable for use in simultaneously preparing two distinct foot items.

As a consequence of the foregoing situation, there has existed a longstanding need for a new and improved crock pot insert and the provision of such a construction is a stated objective of the present invention.

### BRIEF SUMMARY OF THE INVENTION

Briefly stated, the present invention provides an aluminum foil insert that fits into a crock pot. The insert may include one or more divided compartments for separation of different foods to be heated. For example, a two-compartment insert could hold combinations such as ½ cheese dip and ½ bean dip; ½ meat balls and ½ cocktail wieners; or ½ chicken noodle soup and ½ chili. It is understood that the aluminum foil insert could be made in a variety of sizes and shapes, each of which would be matingly received in the interior of a crock pot of like size and shape.

### BRIEF DESCRIPTION OF THE SEVERAL VIEWS OF THE DRAWINGS

These and other attributes of the invention will become more clear upon a thorough study of the following description of the best mode for carrying out the invention, particularly when reviewed in conjunction with the drawings, wherein:

FIG. 1 is a perspective view of a crock pot with a top cover;

FIG. 2 is an exploded perspective view of a crock pot with the top cover and aluminum foil insert removed;

FIG. 3 is a top plan view illustrating a two-compartment aluminum foil insert; and

FIG. 4 is a perspective view showing a two-compartment aluminum foil insert.

### DETAILED DESCRIPTION OF THE INVENTION

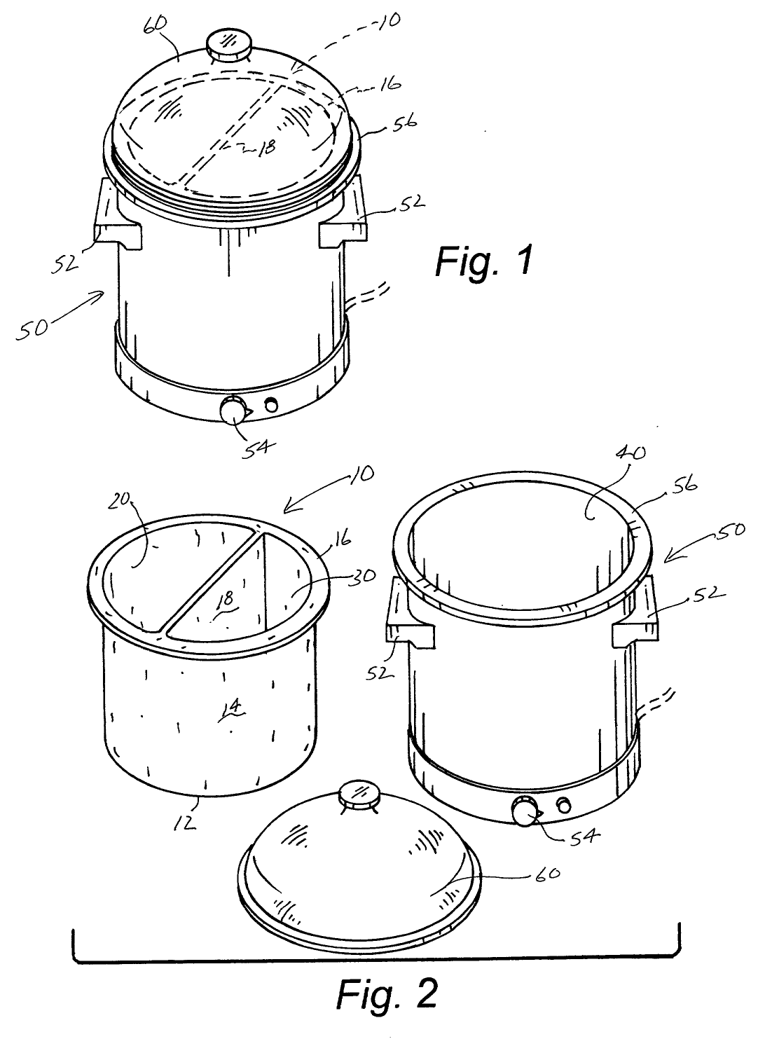

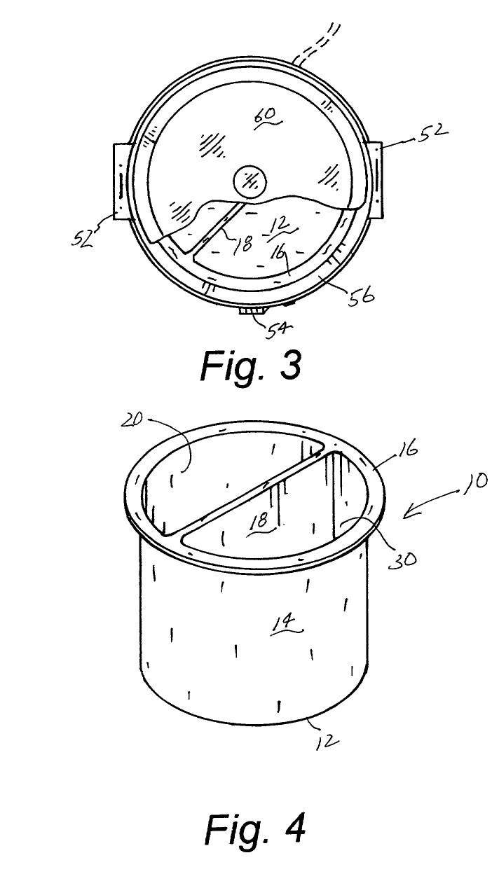

As can be seen by reference to the drawings, and in particularly to FIG. 1, the crock pot insert that forms the basis of the present invention is designated generally by the reference number 10. The insert 10 illustrated is formed of aluminum foil and may either be cleaned and re-used or discarded after use. The insert 10 has a bottom 12 and vertical sidewalls 14 with an outwardly extending flanged rim 16 at the top. A vertically disposed divider 18 defines a common vertical wall of a first compartment 20 and a second compartment 30. It is to be understood that the insert 10 could include additional vertical dividers to form additional compartments.

The divider 10 is matingly received into the interior compartment 40 of a conventional crock pot 50 that includes handles 52, control 54 and an upper rim 56. A top cover 60 selectively closes the top of the crock pot 50.

In use, the insert 10 is placed into the interior cavity 40 of a crock pot 50 with the flanged rim 16 of the insert 10 resting on the upper rim 56 of the crock pot. The ingredients for separate food items to be prepared, such as chicken noodle soup and chili, are placed in the respective first compartment 20 and second compartment 30, the crock pot control 54 is placed at the appropriate setting, and the top cover 60 is put in place. After the preparation time has elapsed, the separate food items are served from the respective first compartment 20 and second compartment 30 as desired.

Although only an exemplary embodiment of the invention has been described in detail above, those skilled in the art will readily appreciate that many modifications are possible without materially departing from the novel teachings and advantages of this invention. Accordingly, all such modifications are intended to be included within the scope of this invention as defined in the following claims.

1. An insert for a crock pot having an interior compartment and an upper rim, the insert comprising:
a body formed of aluminum foil and having a bottom and vertical sidewalls with a shape that conforms to the interior compartment of the crock pot;
a flanged rim extending out from an upper portion of the vertical sidewalls and disposed to engage and rest on the upper rim of the crock pot; and
a vertically disposed divider extending between and connecting the bottom and interior portions of the vertical sidewalls to form a first food compartment and a second food compartment.

2. The insert of claim 1 wherein the divider extends up to the flanged rim.

3. The insert of claim 1 wherein the body is circular in cross-section.

4. The insert of claim 2 wherein the body is circular in cross-section.
